(19) United States
(12) Patent Application Publication
(10) Pub. No.: US 2008/0232224 A1
(43) Pub. Date: Sep. 25, 2008

(54) OPTICAL PICKUP AND OPTICAL DISC DEVICE

(75) Inventors: Yoshiyuki TERAOKA, Kanagawa (JP); Tsuguhiro Abe, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/052,275

(22) Filed: Mar. 20, 2008

(30) Foreign Application Priority Data
Mar. 22, 2007 (JP) 2007-075149

(51) Int. Cl. G11B 7/135

(52) U.S. Cl. 369/112.05; 369/112.22

(57) ABSTRACT

In the present invention, by utilizing the difference between the polarization directions of an optical beam and a reflected optical beam, a neutral density filter part of a variable filter in an optical pickup reduces the light amount of the optical beam and directs the optical beam to the objective lens, and directs the reflected optical beam to a photodetector being a photodetection unit with slight change in the light amount of the reflected optical beam. When reducing a transmitted beam, which is the optical beam transmitted by diffracting the optical beam using a diffraction grating, the irradiation positions of first-order optical beams being diffracted±first-order optical beams on the recording layer of an optical disc are dispersed.

### CROSS REFERENCES TO RELATED APPLICATIONS

The present invention contains subject matter related to Japanese Patent Application JP2007-075149 filed in the Japanese Patent Office on Mar. 22, 2007, the entire contents of which being incorporated herein by reference.

### BACKGROUND OF THE INVENTION

1. Field of the Invention

This invention relates to an optical pickup and an optical disc device, and is desirably applied to, for example, an optical pickup in which a laser diode and a photodetector are closely arranged, and an optical disc device having an optical pickup in which a laser diode and a beam splitter are closely arranged.

2. Description of the Related Art

In an optical pickup, the rating of a laser diode is selected according to a two-layer disc for which a larger irradiation light amount is demanded as compared with a one-layer disc.

In the optical pickup, for a one-layer disc, the output of a laser diode needs to be largely reduced. It is known that, in general, when a laser diode is used with its output made small, the rate of noise with respect to the light amount of an outgoing optical beam is increased. Accordingly, when making the irradiation light amount with respect to an optical disc small by simply reducing the output of a laser diode, the noise in an optical beam is undesirably increased.

Accordingly, as shown in FIG. 1, there has been proposed a configuration in which a variable filter 2 having a high transmission part that transmits substantially 100% of an optical beam and a neutral density filter part that blocks part of an optical beam is arranged in an optical pickup 1 (for example, refer to Jpn. Pat. Appln. Laid-Open Publication No. 2002-260272).

In the optical pickup 1, at the time of the reproduction and record processing with respect to a two-layer disc for which a large irradiation light amount is demanded, an optical beam is made to pass through the high transmission part. At the time of the reproduction and record processing with respect to a one-layer disc for which a small irradiation light amount is demanded, an optical beam is made to pass through the neutral density filter part. Accordingly, a large irradiation light amount is assured at the time of the record processing, and a laser diode is used with high output to suppress the noise in an optical beam at the time of the reproduction processing.

In the optical pickup 1, the variable filter 2 is arranged between a laser diode 11 and a beam splitter 17. Accordingly, in the optical pickup 1, at the time of the reproduction processing, an optical beam 40 is made to pass through the neutral density filter part of the variable filter 2 to reduce the light amount of the optical beam 40 irradiated from the laser diode 11, while the direction of a reflected optical beam 50 which is obtained when the optical beam 40 is reflected by an optical disc 100 is directed to a photodetector 22 by changing the direction thereof using the beam splitter 17. Accordingly, the reflected optical beam 50 is not made to pass through the variable filter 2 so as not to reduce the light amount of the reflected optical beam 50.

### SUMMARY OF THE INVENTION

Meanwhile, in the optical pickup 1, due to the downsizing, there is employed a configuration in which optical components which can be downsized are assembled as an integrated optical circuit, and are dealt with as one component. As shown in FIG. 2, in an integrated optical circuit 4, the laser diode 11, photodetector 22, and optical components which are arranged closely to these are assembled.

When arranging the above-described variable filter 2 in the optical pickup 1 using the integrated optical circuit 4, the variable filter 2 comes to be arranged between the integrated optical circuit 4 and an objective lens 20, and the variable filter 2 is arranged on the shared light path of the optical beam 40 and reflected optical beam 50.

When the variable filter 2 is arranged on the shared light path of the optical beam 40 and reflected optical beam 50, not only the optical beam 40 but also the reflected optical beam 50 comes to pass through the variable filter 2. That is, at the time of the reproduction and record processing with respect to a one-layer disc, also the reflected optical beam 50 comes to pass through the neutral density filter part, and the received light amount of the reflected optical beam 50 which is received by the photodetector 22 is reduced, which deteriorates the reproduction characteristics.

Accordingly, it is considered that, by using a diffraction grating provided with the polarization dependence as the neutral density filter part, the optical beam 40 can be reduced with use of the difference between the polarization directions of the optical beam 40 and the reflected optical beam 50, but the reflected optical beam 50 can be transmitted directly.

However, when a diffraction grating is used as the neutral density filter part, at the time of the record processing when the light intensity of the optical beam 40 need to be large, the first-order optical beams which are diffracted by the diffraction grating are irradiated to the recording layer of the optical disc 100. Accordingly, there is raised a problem that the first-order optical beams adversely affect the optical disc 100 such as deleting recording marks recorded on the recording layer, or deteriorating the recording layer.

In view of the above-identified circumstances, it is therefore desirable to provide an optical pickup and an optical disc device which represent desirable reproduction characteristics even if a neutral density filter part is arranged on the shared light path of the optical beam and reflected the optical beam, and which do not adversely affect an optical disc.

According to an aspect of the present invention, there is provided an optical pickup including: a light source that irradiates an optical beam being a linearly polarized light; an objective lens that condenses the optical beam to make thus condensed optical beam go to an optical disc, and receives a reflected optical beam reflected by the optical disc; a beam splitter that separates the optical beam and the reflected optical beam; a quarter-wave plate that converts the optical beam directed from the beam splitter to a circularly polarized light, and converts the reflected optical beam directed to the beam splitter from a circularly polarized light to a polarization direction perpendicular to the optical beam; a photodetection unit that receives the separated reflected optical beam; a neutral density filter part that is arranged on the shared light path of the optical beam and the reflected optical beam, and, with use of the difference between the polarization directions of the optical beam and the reflected optical beam, reduces the light amount of the optical beam to direct the optical beam to the objective lens, and directs the reflected optical beam to the photodetection unit with slight change in the light amount of the reflected optical beam; and a filter drive unit that drives the neutral density filter part on the light path of the optical beam and the reflected optical beam or to the outside of the light path to control the light amount of the optical beam irradiated from the light source so that the optical beam irradiated to the optical disc has a predetermined irradiation light amount, the neutral density filter part reducing the optical beam that goes through a diffraction grating after diffracted by the diffraction grating, and dispersing the irradiation positions of diffracted±first-order optical beams on the recording layer of the optical disc.

Accordingly, when the neutral density filter part is driven on the light path, since the light amount can be selectively reduced with respect to an optical beam irradiated to the optical disc, the neutral density filter part can be arranged on the shared light path of the optical beam and the reflected optical beam, and the irradiation area of the first-order optical beams on the recording layer of the optical disc can be made large. Thus, the light intensity of the first-order optical beams for unit area can be reduced.

According to an aspect of the present invention, there is also provided an optical disc device including: a light source that irradiates an optical beam of a linearly polarized light; an objective lens that condenses the optical beam to make thus condensed optical beam go to an optical disc, and receives a reflected optical beam reflected by the optical disc; a beam splitter that separates the optical beam and the reflected optical beam; a quarter-wave plate that converts the optical beam directed from the beam splitter to a circularly polarized light, and converts the reflected optical beam directed to the beam splitter from a circularly polarized light to a polarization direction perpendicular to the optical beam; a photodetection unit that receives the separated reflected optical beam; a neutral density filter part that is arranged on the shared light path of the optical beam and the reflected optical beam, and, with use of the difference between the polarization directions of the optical beam and the reflected optical beam, reduces the light amount of the optical beam to direct the optical beam to the objective lens, and directs the reflected optical beam to the photodetection unit with slight change in the light amount of the reflected optical beam; a filter drive unit that drives the neutral density filter part on the light path of the optical beam and the reflected optical beam or to the outside of the light path; and an irradiation light amount control unit that controls the light amount of the optical beam irradiated from the light source and the filter drive unit so that the optical beam irradiated to the optical disc has a predetermined irradiation light amount, the neutral density filter part reducing the optical beam that goes through a diffraction grating after diffracted by the diffraction grating, and dispersing the irradiation positions of diffracted±first-order optical beams on the recording layer of the optical disc.

Accordingly, when the neutral density filter part is driven on the light path, since the light amount can be selectively reduced with respect to an optical beam irradiated to the optical disc, the neutral density filter part can be arranged on the shared light path of the optical beam and the reflected optical beam, and the irradiation area of the first-order optical beams on the recording layer of the optical disc can be made large. Thus, the light intensity of the first-order optical beams for unit area can be reduced.

According to the present invention, when the neutral density filter part is driven on the light path, since the light amount can be selectively reduced with respect to an optical beam irradiated to the optical disc, the neutral density filter part can be arranged on the shared light path of the optical beam and the reflected optical beam, and the irradiation area of the first-order optical beams on the recording layer of the optical disc can be made large. Thus, the light intensity of the first-order optical beams for unit area can be reduced. In this way, even if the neutral density filter part is arranged on the shared light path of the optical beam and the reflected optical beam, desirable reproduction characteristics can be represented, and it becomes possible to realize an optical pickup and an optical disc device which do not exert a bad influence on the optical disc.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 shows a schematic view indicative of the configuration of a conventional optical pickup;

FIG. 2 shows a schematic view to explain the reduction of a reflected optical beam due to the arrangement of a variable filter;

FIG. 3 shows a schematic view indicative of the entire configuration of an optical disc device;

FIG. 4 shows a schematic view indicative of the arrangement of a variable filter in the record processing;

FIG. 5A and FIG. 5B show schematic views to explain the effect of a filter plate;

FIG. 6 shows a schematic view indicative of the arrangement of the variable filter in the reproduction processing;

FIG. 7A and FIG. 7B show schematic views indicative of the configuration of a diffraction grating and a diffracted beam;

FIG. 8A and FIG. 8B show schematic views to explain a conventional stripe diffraction grating;

FIG. 9A and FIG. 9B show schematic views to explain the division of a diffraction grating by the change of grating angles;

FIG. 10A and FIG. 10B show schematic views to explain the division of a diffraction grating by the change of periods;

FIG. 11A and FIG. 11B show schematic views to explain the combination (1) of diffraction gratings;

FIG. 12A and FIG. 12B show schematic views to explain the combination (2) of diffraction gratings; and

FIG. 13A and FIG. 13B show schematic views to explain a concentric diffraction grating.

### DETAILED DESCRIPTION OF THE PREFERRED EMBODIMENTS

Now, an embodiment of the present invention will be described in greater detail by referring to the accompanying drawings.

### (1) Overall Configuration of Optical Disc Device

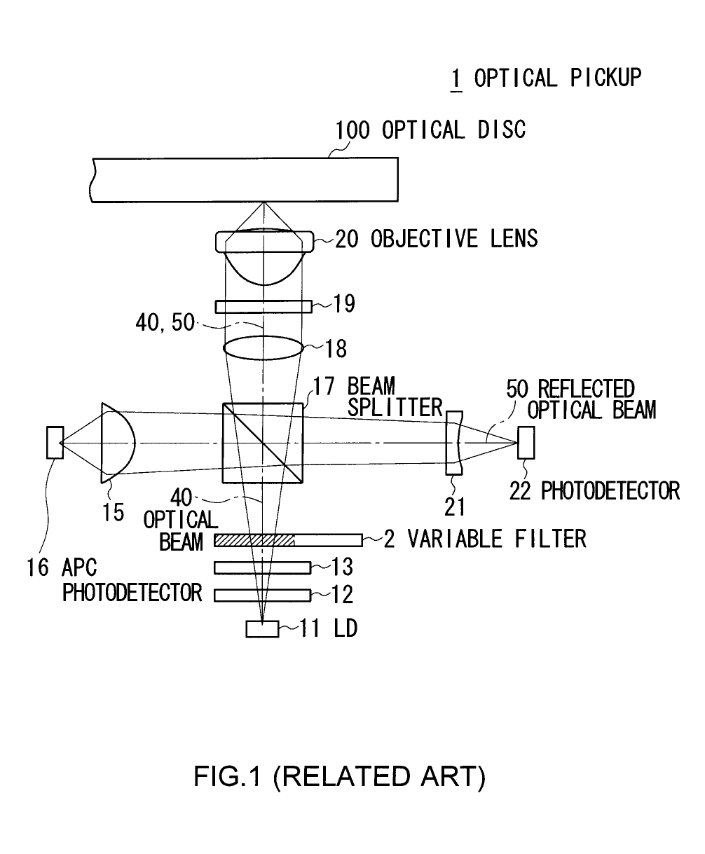

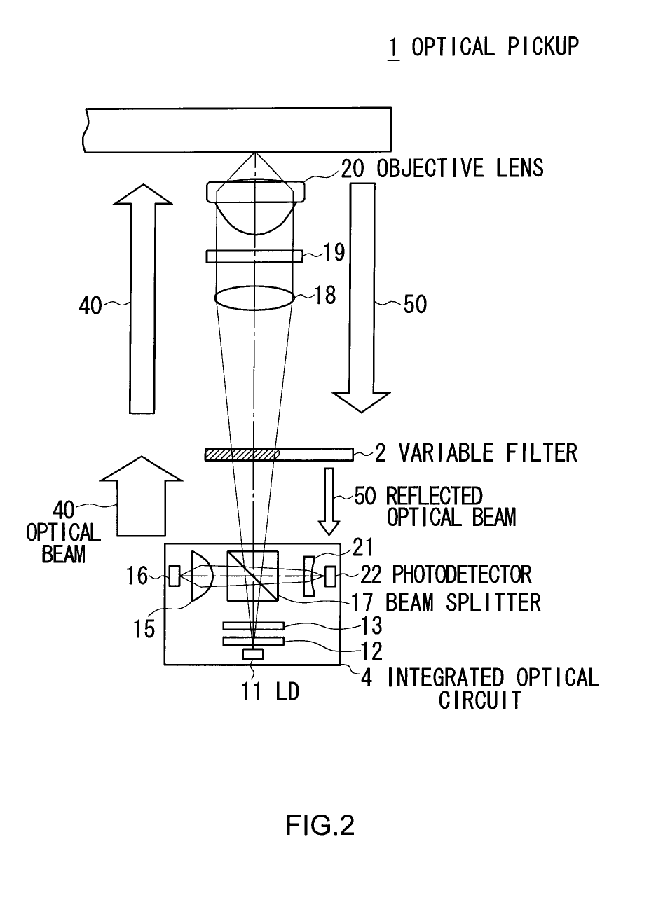

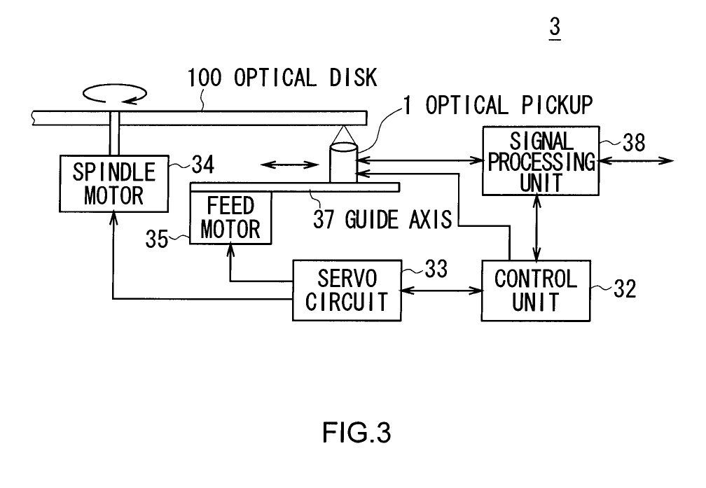

In FIG. 3, a reference numeral “3” represents an optical disc device, and parts or components similar to those in FIG. 1 and FIG. 2 are indicated with the same reference numerals. The optical disc device 3 corresponds to both a one-layer disc 100a having only one signal recording layer such as a Compact Disc (CD) and a two-layer disc 100b having two signal recording layers such as a Blu-ray Disc (BD, registered trademark) as an optical disc 100.

A control unit 32 includes a Central Processing Unit (CPU), a Read Only Memory (ROM) in which various programs are stored, and a Random Access Memory (RAM) as a work memory for the CPU, and controls respective units of the optical disc device 3.

That is, the control unit 32 rotates a spindle motor 34 through a servo circuit 33, and drives and rotates the optical disc 100 placed on a turntable (not shown). The control unit 32 drives a feed motor 35 through the servo circuit 33, and moves an optical pickup 1 in the tracking direction that is the radius direction of the optical disc 100 along a guide axis 37. Further, the control unit 32 controls the optical pickup 1 to execute the reproduction and record processing with respect to the optical disc 100.

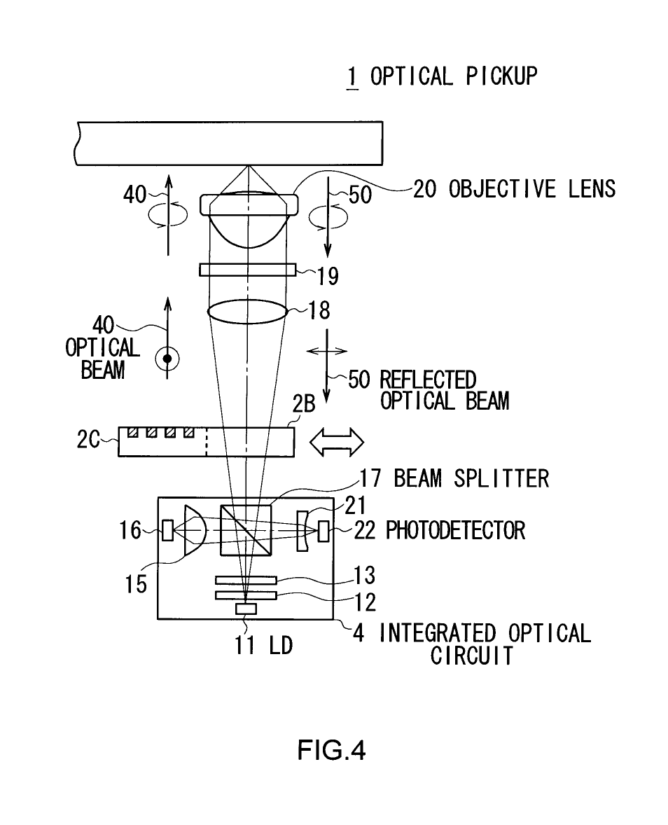

As shown in FIG. 4, a laser diode 11 of the optical pickup 1 irradiates a laser beam having a wavelength corresponding to the respective systems of the optical disc 100 with a light amount corresponding to a drive current supplied from the control unit 32, and makes the laser beam enter a diffraction grating 13 through a half-wave plate 12 as an optical beam 40.

The diffraction grating 13 separates the optical beam 40 to a main beam used for the reproduction and record processing with respect to the optical disc 100 and a sub beam for generating various tracking control signals, and makes the main beam and sub beam enter a beam splitter 17 as the optical beam 40.

The beam splitter 17 transmits most of the incoming optical beam 40 directly, and makes the optical beam 40 enter the variable filter 2. The variable filter 2 adjusts the light amount of the optical beam 40 according to the one-layer disc and two-layer disc, details of which will be explained later, and makes the optical beam 40 enter a collimator lens 18. The collimator lens 18 converts the optical beam 40 which comes in as a divergent beam to a parallel beam, and makes thus converted parallel beam enter a quarter-wave plate 19.

The quarter-wave plate 19 converts the optical beam 40 of an S-polarized light to a circularly polarized light, and makes the circularly polarized light enter an objective lens 20. The objective lens 20 condenses the optical beam 40, and makes thus condensed optical beam 40 enter the optical disc 100.

Then, the objective lens 20 receives a reflected optical beam 50 which is obtained when the optical beam 40 is reflected by the optical disc 100, and makes the reflected optical beam 50 enter the quarter-wave plate 19. The quarter-wave plate 19 converts the optical beam 40 of a circularly polarized light to a P-polarized light of a linearly polarized light, and makes the P-polarized light enter the beam splitter 17 through the collimator lens 18 and variable filter 2.

The beam splitter 17 reflects the incoming reflected optical beam 50 using the polarization plane thereof, and changes the direction of the beam by 90° to make the beam enter a photodetector 22 through a multi lens 21 that corrects the aberration. Then, the photodetector 22 performs the photoelectric conversion with respect to the reflected optical beam 50 to generate a detection signal, and supplies the detection signal to a signal processing unit 38 (FIG. 3).

The signal processing unit 38 generates a reproduction RF signal and various servo control signals from the detection signal. The control unit 32 generates a drive control signal based on the servo control signals supplied from the signal processing unit 38, and drives the objective lens 20 in the focus direction and tracking direction so that the optical beam 40 is correctly irradiated to a desired track of the optical disc 100.

Furthermore, the beam splitter 17 (FIG. 4) separates part of the optical beam 40 by reflecting the optical beam 40 using the polarization plane thereof with a predetermined light amount ratio, and makes the separated beam enter an APC photodetector 16 through an Auto Power Control (APC) lens 15. The APC photodetector 16 detects the light amount of the incoming optical beam 40, generates an APC detection current of a current value corresponding to the light amount, and supplies the APC detection current to the control unit 32.

The control unit 32 increases and decreases a drive current supplied to a laser diode 11 and adjusts the output of the laser diode 11 so that the APC detection current has a predetermined current value in order to control the intensity (referred to as irradiation light intensity, hereinafter) of the optical beam 40 irradiated from the laser diode 11 so that the intensity comes to a predetermined value according to the type of the optical disc and the number of the recording layers of the optical disc 100.

At this time, the control unit 32 adjusts the output of the laser diode 11 so that the irradiation light amount with respect to the optical disc 100 at the time of the record processing becomes larger than the irradiation light amount at the time of the reproduction processing. Since the loss of the optical beam 40 irradiated to the respective signal recording layers of the two-layer disc 100b becomes larger as compared with that of the one-layer disc 100a, the control unit 32 drives the variable filter 2 so that the irradiation light amount with respect to the two-layer disc 100b becomes larger than the irradiation light amount with respect to the one-layer disc 100a, and adjusts the output of the laser diode 11.

In this way, the optical disc device 3 executes the reproduction processing and record processing with respect to the optical disc 100.

On the other hand, in the optical pickup 1, the variable filter 2, which has a high transmission part 2B used at the time of the record processing and a neutral density filter part 2C used at the time of the reproduction processing, is arranged between the beam splitter 17 and the objective lens 20.

Thus, as shown in FIG. 4, the optical beam 40 irradiated from the laser diode 11 passes through variable filter 2 before going to the optical disc 100, and the reflected optical beam 50 reflected by the optical disc 100 passes through the variable filter 2 again.

Accordingly, when using the conventional variable filter 2 (FIG. 1), when the light amount of the optical beam 40 is reduced by making the beam pass through the neutral density filter part 2C at the time of the reproduction processing, the light amount of the reflected optical beam 50 passing through the neutral density filter part 2C is also reduced undesirably.

Accordingly, in the optical pickup 1, the neutral density filter part 2C selectively adjusts the light amount of only the optical beam 40.

### (2) Variable Filter

### (2-1) Configuration of Variable Filter

Next, the configuration of the variable filter 2 will be explained. In this embodiment, with use of the fact that the optical beam 40 is a P-polarized light and the reflected optical beam 50 is an S-polarized light, the neutral density filter part 2C reduces the light amount of the optical beam 40, but scarcely change the light amount of the reflected optical beam 50.

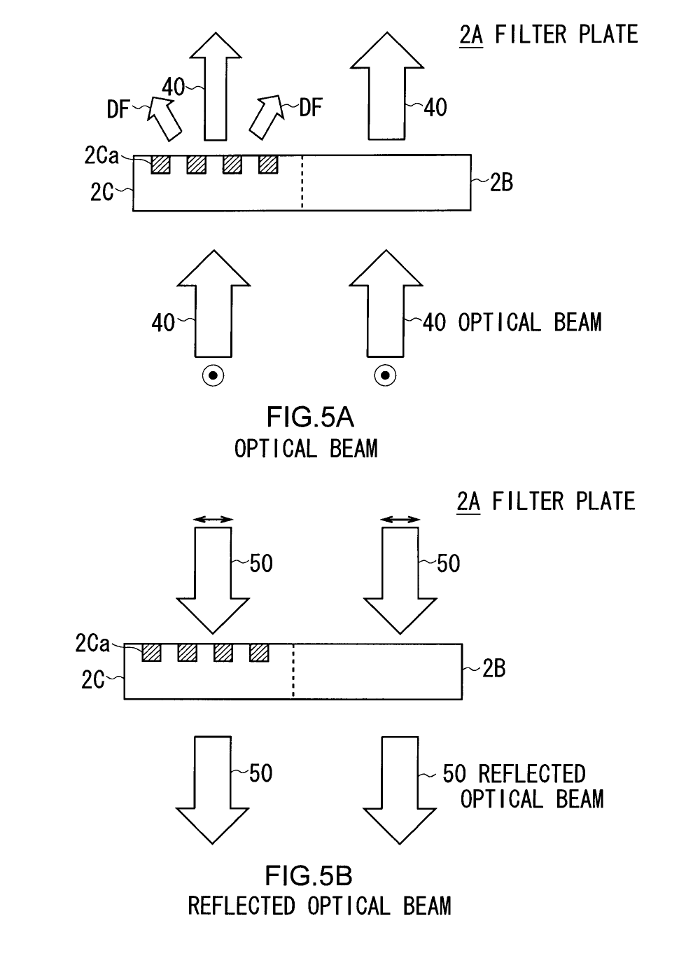

The variable filter 2 is configured by a filter plate 2A and an electromagnetic actuator (not shown). As shown in FIG. 5A and FIG. 5B, the filter plate 2A has the high transmission part 2B that transmits most of the optical beam 40 directly and the neutral density filter part 2C that blocks part of the optical beam 40. Accordingly, by driving the filter plate 2A according to a drive current supplied from the control unit 32, the variable filter 2 makes the optical beam 40 pass through any one of the high transmission part 2B and neutral density filter part 2C.

The high transmission part 2B is a transparent flat plate, and makes most of an incoming beam pass therethrough irrespective of the polarization direction of the beam, and accordingly scarcely reduces both the light amount of the optical beam 40 (FIG. 5A) being an S-polarized light and the light amount of the reflected optical beam 50 (FIG. 5B) being a P-polarized light.

On the other hand, the neutral density filter part 2C is provided with the polarization characteristics, and reflects approximately 50% of an optical beam being an S-polarized light, and transmits approximately the remaining 50% thereof, while transmits most of an optical beam being a P-polarized light. That is, the neutral density filter part 2C reduces the light amount of the optical beam 40 being an S-polarized light by 50% (FIG. 5A), while scarcely reduces the light amount of the reflected optical beam 50 being a P-polarized light (FIG. 5B). The configuration of the neutral density filter part 2C will be explained later.

Accordingly, at the time of the record processing, the control unit 32 drives the filter plate 2A so that the optical beam 40 and the reflected optical beam 50 pass through the high transmission part 2B, as shown in FIG. 4.

At this time, the high transmission part 2B transmits most of the optical beam 40 entering from the beam splitter 17, and makes the beam enter the collimator lens 18. Furthermore, the high transmission part 2B transmits most of the reflected optical beam 50 entering from the collimator lens 18, and makes the beam enter the beam splitter 17.

Accordingly, at the time of the reproduction and record processing with respect to the two-layer disc 100b for which a large irradiation light amount is demanded as compared with the one-layer disc 100a, the optical pickup 1 scarcely reduces the light amount of the optical beam 40 when making the beam pass through the variable filter 2, making it possible to assure a sufficient irradiation light amount.

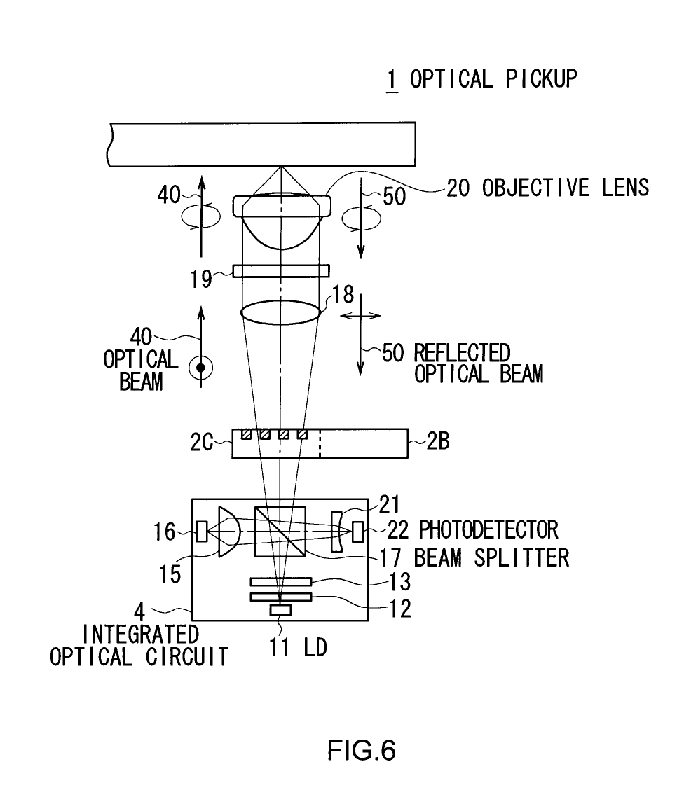

On the other hand, at the time of the reproduction and record processing with respect to the one-layer disc 100a, the control unit 32 drives the filter plate 2A so that the optical beam 40 and the reflected optical beam 50 pass through the neutral density filter part 2C, as shown in FIG. 6.

At this time, by transmitting only approximately 50% of the optical beam 40 entering from the beam splitter 17, the neutral density filter part 2C reduces the light amount of the optical beam 40, and makes the beam enter the collimator lens 18.

Accordingly, the control unit 32 sets the irradiation light intensity of the laser diode 11 to approximately two times that in the case in which the variable filter 2 is not arranged, and can make the Signal to Noise (S/N) ratio of the optical beam 40 large.

Furthermore, the neutral density filter part 2C transmits most of the reflected optical beam 50 entering from the collimator lens 18 directly, and makes the beam enter the beam splitter 17. Accordingly, the neutral density filter part 2C does not reduce the received light amount of the reflected optical beam 50 in the photodetector 22, which does not lowers the quality of a reproduction RF signal and various servo control signals which are reproduced signals generated according to the received light amount.

In this way, by utilizing the difference between the polarization directions of the optical beam 40 and the reflected optical beam 50, the neutral density filter part 2C reflects part of the optical beam 40 using a diffraction grating GT to reduce the light amount thereof, and scarcely reduces the light amount of the reflected optical beam 50. Thus, even at the time of the reproduction and record processing with respect to the one-layer disc 100a, the laser diode 11 can be used with high output, and it is possible not to reduce the received light amount of the reflected optical beam 50 in the photodetector 22.

### (2-2) Configuration of Neutral Density Filter Part

Next, the configuration of the neutral density filter part 2C will be explained.

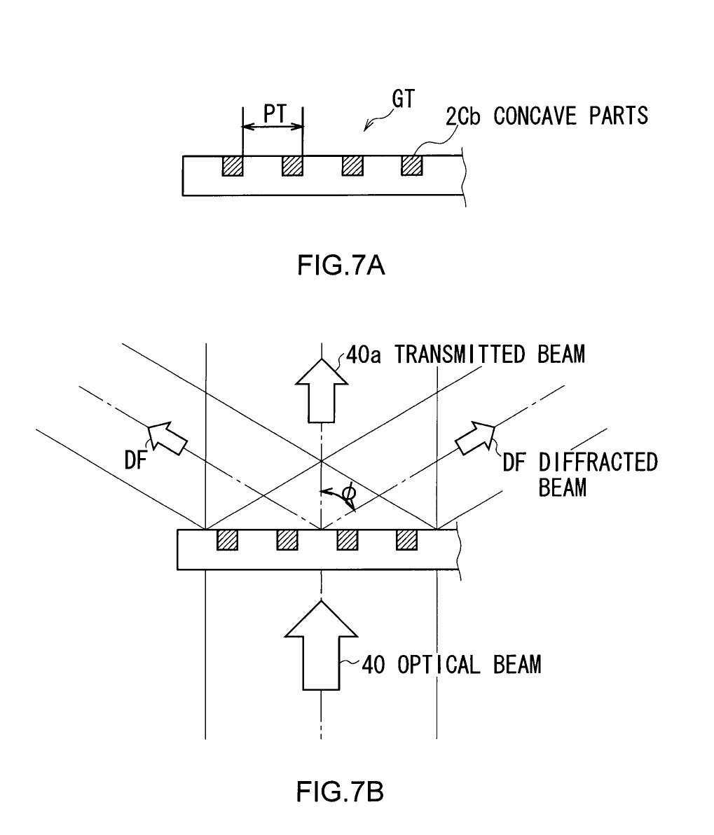

The neutral density filter part 2C is a grating provided with the polarization characteristics, and, as shown in FIG. 7A, has a flat plate shape as a whole. The neutral density filter part 2C has the diffraction grating GT of the concavo-convex configuration using an optical material which does not represent the birefringence characteristics arranged on one surface thereof, and has a concave parts 2Cb of the diffraction grating GT filled with a birefringent material, which flattens the surface of the diffraction grating GT.

As the birefringent material of the concave parts 2Cb, there is used a material which represents a refractive index different from that of the optical material of the diffraction grating GT with respect to an optical beam being a P-polarized light. On the other hand, there is used a material which represents a refractive index equal to that of the optical material of the diffraction grating GT with respect to an optical beam being an S-polarized light.

Accordingly, the neutral density filter part 2C which is used at the time of the reproduction and record processing with respect to the one-layer disc 100a functions as a grating for the optical beam 40 being a P-polarized light, and directly transmits the optical beam 40 by diffracting approximately 50% of the optical beam 40 to reduce the light amount of the optical beam 40 (referred to as transmitted beam 40a, hereinafter) irradiated to a desired track of the one-layer disc 100a through the objective lens 20 (FIG. 6) by about 50%. The neutral density filter part 2C also functions as merely a flat plate for the reflected optical beam 50 being an S-polarized light, and directly transmits the reflected optical beam 50.

Under the Rewritable (BD-RE) standard, it is demanded that the one-layer disc 100a can reproduce data even if the transmitted beam 40a whose light intensity as the entire main spot MS (referred to as main spot light intensity, hereinafter), which is obtained when the optical beam 40a is irradiated on the recording layer at the time of the reproduction processing with a single speed, is 0.40 mW is irradiated thereto by one million times (that is, reproduction durability with respect to one million times irradiation). Under the BD-RE standard, it is stipulated that data is recorded to the one-layer disc 100a with the main spot light intensity of 6.0 mW or lower at the time of the record processing with a single speed.

Furthermore, on the recording layer of the one-layer disc 100a, of diffracted optical beams which are diffracted by the diffraction grating GT, whether or not the first-order optical beams DF which are the±first-order optical beams whose light amount is largest adversely affects the peripheral part of a desired track (referred to as track peripheral part, hereinafter) depends on the light amount for unit area of the first-order light spots SS which are obtained when the first-order optical beams DF are irradiated on the recording layer.

In general, since the objective lens 20 is optimized with respect to the transmitted beam 40a, the area of the respective first-order light spots SS becomes larger than that of the main spot MS by the transmitted beam 40a. Hereinafter, the light intensity of the first-order light spots SS when the area of the main spot MS is set as a unit is set to the first-order spot light intensity.

Accordingly, at the time of the record processing with respect to the one-layer disc 100a, when the area of the main spot MS is substantially equal to that of the respective first-order light spots, and when the diffraction grating GT can set the first-order spot light intensity to 0.40 mW or lower, that is, 6.7% (0.40/6.0×100≈6.67%) or lower with respect to the maximum main spot light intensity (6.0 mW) of the transmitted beam 40a, even if data is recorded with the maximum main spot light intensity (6.0 mW) at the time of the record processing with a single speed, it can be considered that an adverse affect is not substantially given on the track peripheral part.

Similarly, for the one-layer disc 100a, reproduction durability with respect to one million times irradiation of the transmitted beam 40a whose spot intensity is the maximum 0.44 mW is demanded at the time of the reproduction processing with a double speed, and it is stipulated that data is recorded with a main spot light intensity of the maximum 7.0 mW at the time of the record processing with a double speed.

Therefore, when the diffraction grating GT can set the first-order spot light intensity to 0.44 mW or lower, that is, 6.3% (0.44/7.0×100≈6.29%) or lower with respect to the maximum main spot light intensity (7.0 mW) of the transmitted beam 40a, even if data is recorded with the maximum main spot light intensity (7.0 mW) at the time of the record processing with a double speed, it can be considered that an adverse affect is not substantially given on the track peripheral part.

Accordingly, in this embodiment, the diffraction pattern profile of the diffraction grating GT of the neutral density filter part 2C is selected so that the first-order spot light intensity comes to be 6.3% or lower of the main spot light intensity.

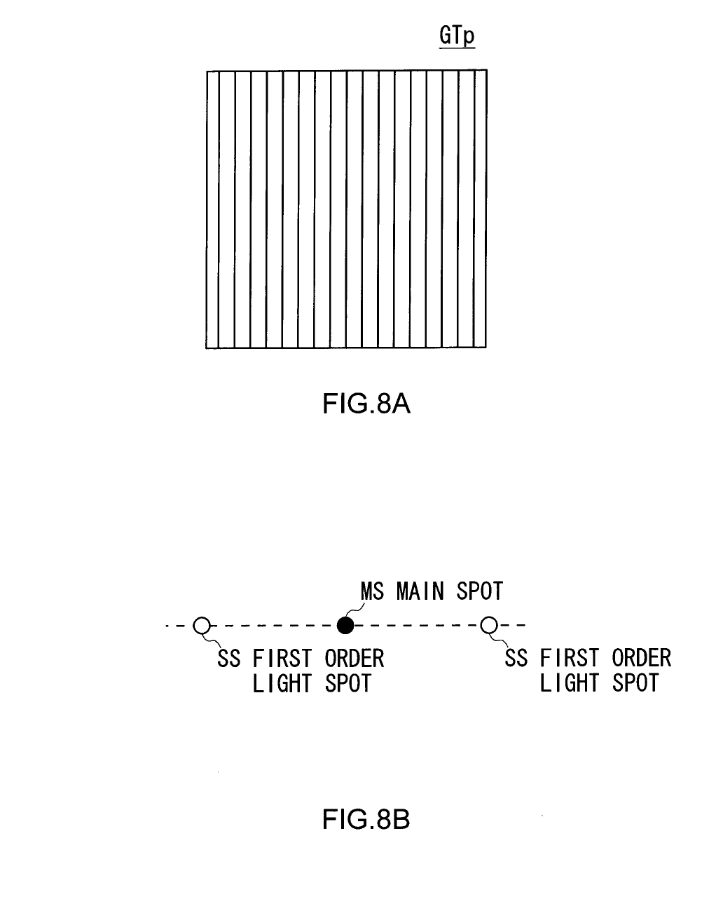

When diffracting the optical beam 40, as shown in FIG. 7B, a conventional stripe diffraction grating GTp provided with the diffraction pattern in the form of stripes shown in FIG. 8A separates the optical beam 40 to the transmitted beam 40a being the zero-order optical beam, two first-order optical beams DF being the±first-order optical beams, and high order optical beams (not shown) of±second order or more.

As shown in FIG. 7A and FIG. 7B, the conventional stripe diffraction grating GTp diffracts the first-order optical beams DF in directions such that they are symmetric with each other on a perpendicular line with respect to the stripes of the stripe diffraction grating GTp with a diffraction angle φ (FIG. 7B) according to a period PT (FIG. 7A) of the stripe diffraction grating GTp. As a result, as shown in FIG. 8B, in the optical pickup 1 using the conventional stripe diffraction grating GTp, on the one-layer disc 100a, two first-order light spots SS by the first-order optical beams DF are irradiated to symmetric positions with the main spot MS by the transmitted beam 40a sandwiched therebetween.

When the conventional stripe diffraction grating GTp (FIG. 8A) diffracts approximately 50% of the optical beam 40, the diffraction grating GTp separates approximately 20% of the light amount as high order optical beams of second order or more. Thus, the total light amount of the two first-order optical beams DF comes to be approximately 30%, and the light amount for the one first-order optical beam DF comes to be approximately 15% of the entire incoming optical beam 40.

That is, in the optical pickup 1 using the conventional stripe diffraction grating GTp, when irradiating the transmitted beam 40a to a desired track of the optical disc 100, if the main spot light intensity of the optical beam 40 is 100%, there is a possibility that the first-order optical beams DF of the first spot light intensity of approximately 30% are irradiated to the track peripheral part.

Accordingly, in order to reduce the 30% to 6.3%, since 30% divided by 6.3% is 4.76 (30%/6.3%≈4.76), when the main spot light intensity can be set to approximately ⅕ of the conventional stripe diffraction grating GTp, the diffraction grating GT can prevent an adverse affect by the first-order optical beams DF from being given on the track peripheral part at the time of the record processing with any of a single speed and a double speed. The diffraction pattern profile of the diffraction grating GT which satisfies the condition will be explained with specific examples.

### (2-3) Diffraction Pattern Profile of Diffraction Grating

### (2-3-1) Division of Diffraction Grating by Change of Grating Angles

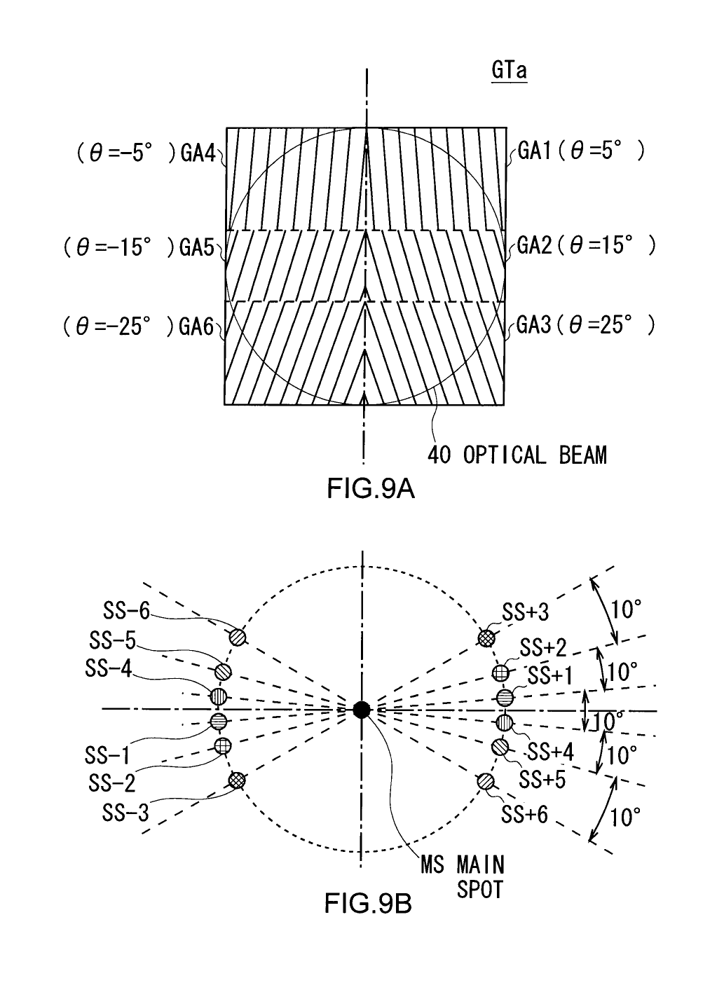

As shown in FIG. 9A and FIG. 9B, a diffraction grating GTa of the neutral density filter part 2C has six grating regions GA1 to GA6 whose grating angles θ of the diffraction pattern are different from each other, and diffracts the optical beam 40 using the respective grating regions GA1 to GA6 respectively to separate light fluxes of the first-order optical beams DF to total 12. As a result, in the optical pickup 1 using the neutral density filter part 2C having the diffraction grating GTa, the first-order optical beams DF are dispersed to different irradiation positions on the recording layer of the optical disc 100, and irradiated thereto as twelve first-order light spots SS ±1 to SS ±6.

Since the optical beam 40 has the Gaussian distribution, the light amount of the central part thereof is larger than that of the peripheral part. The diffraction grating GTa adjusts the areas of the respective grating regions GA1 to GA6 such that the light amounts of the optical beam 40 passing through the respective grating regions GA1 to GA6 become substantially equal to each other, to make the area of the grating regions GA2 and GA5, which are central parts, smaller than the area of the other grating regions GA1, GA3, GA4, GA6. A circle which is drawn in the diffraction grating GTa shown in FIG. 9A represents the light flux of the optical beam 40.

As a result, in the optical pickup 1 using the neutral density filter part 2C having the diffraction grating GTa, since the first-order spot light intensities in the respective first-order light spots SS ±1 to SS ±6 can be made equal to each other, the respective first-order spot light intensities can be set to approximately ⅙ of the conventional stripe diffraction grating GTp, that is, reduced to approximately 5% of the main spot light intensity.

Furthermore, the diffraction grating GTa changes the angle of the grating (referred to as grating angle, hereinafter) θ with respect to a central division line CS passing through the center by 10° (θ=5° in the grating region GA1, θ=15° in the grating region GA2, θ=25° in the grating region GA3, θ=−5° in the grating region GA4, θ=−15° in the grating region GA5, θ=−25° in the grating region GA6).

As a result, in the optical pickup 1 using the neutral density filter part 2C having the diffraction grating GTa, the twelve first-order light spots SS ±1 to SS ±6 which are diffracted by the six grating regions GA1 to GA6 are rotated by 10° respectively with the main spot MS set to the central point, and can be irradiated to positions which are separate mutually sufficiently. Thus, the first-order light spots SS can be surely prevented from overlapping each other so as not to partially increase.

In this way, in the diffraction grating GTa, the diffraction grating GTa is divided to the six grating regions GA1 to GA6 and the diffraction pattern is changed to separate the light fluxes of the first-order optical beams DF to total 12. The grating angles θ of the respective grating regions GA1 to GA6 are made different from each other to disperse the irradiation positions of the first-order optical beams DF irradiated on the recording layer of the one-layer disc 100a (that is, irradiation positions of the first-order light spots SS). Accordingly, the total area of the first-order light spots SS can be increased, and the first-order spot light intensity can be sufficiently reduced.

The division number of the grating regions GA is not restricted so long as the grating regions GA are divided to five or more regions. The respective grating regions GA do not need to be divided such that the light amounts of the optical beam 40 come to be equal to each other. For example, the diffraction grating GTa may be divided to six equally, and the division number can be freely set within a range in which the first-order spot light intensity of the respective first-order light spots does not exceed 6.3% of the main spot light intensity. Furthermore, the grating angle θ of the diffraction pattern of the respective grating regions GA1 to GA6 is not restricted, and the grating angle θ can be freely changed within a range in which the first-order light spots SS are sufficiently separated and irradiated.

### (2-3-2) Division of Diffraction Grating by Change of Periods

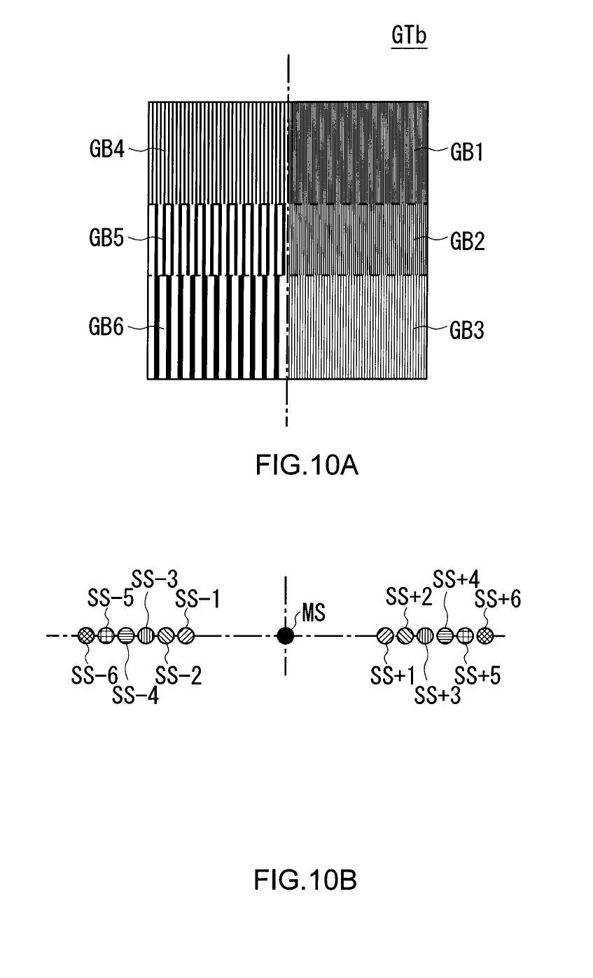

A diffraction grating GTb shown in FIG. 10A has six grating regions GB1 to GA6 which have their areas adjusted such that the light amounts of the optical beam 40 passing therethrough come to be substantially equal to each other similar to the case shown in FIG. 9A and FIG. 9B.

In the diffraction grating GTb, while the grating angles e in the respective grating regions GB1 to GA6 are equal to each other, by making the periods PT shown in FIG. 7B different from each other, the diffraction angles φ shown in FIG. 7A of the first-order optical beams DF diffracted in the respective regions GB1 to GA6 can be made different from each other.

As a result, in the optical pickup 1 using the neutral density filter part 2C having the diffraction grating GTb, as shown in FIG. 10B, twelve first-order light spots ±1 to ±6 can be irradiated to different positions on the same straight line including the main spot MS. Accordingly, the respective first-order spot light intensities can be set to approximately ⅙ of the conventional stripe diffraction grating GTp, that is, reduced to approximately 5% of the transmitted beam 40a.

In this way, in the diffraction grating GTb, the diffraction grating GTa is divided to six grating regions GB1 to GA6 whose diffraction patterns are different from each other, and, by making the periods PT of the respective grating regions GB1 to GA6 different from each other discontinuously and separating the light fluxes of the first-order optical beams DF, the irradiation positions (that is, irradiation positions of the first-order light spots SS) of the first-order optical beams DF irradiated on the one-layer disc 100a are largely dispersed and the total area of the first-order light spots SS can be increased, which can sufficiently reduce the first-order spot light intensity.

### (2-3-3) Crossing of Diffraction Pattern

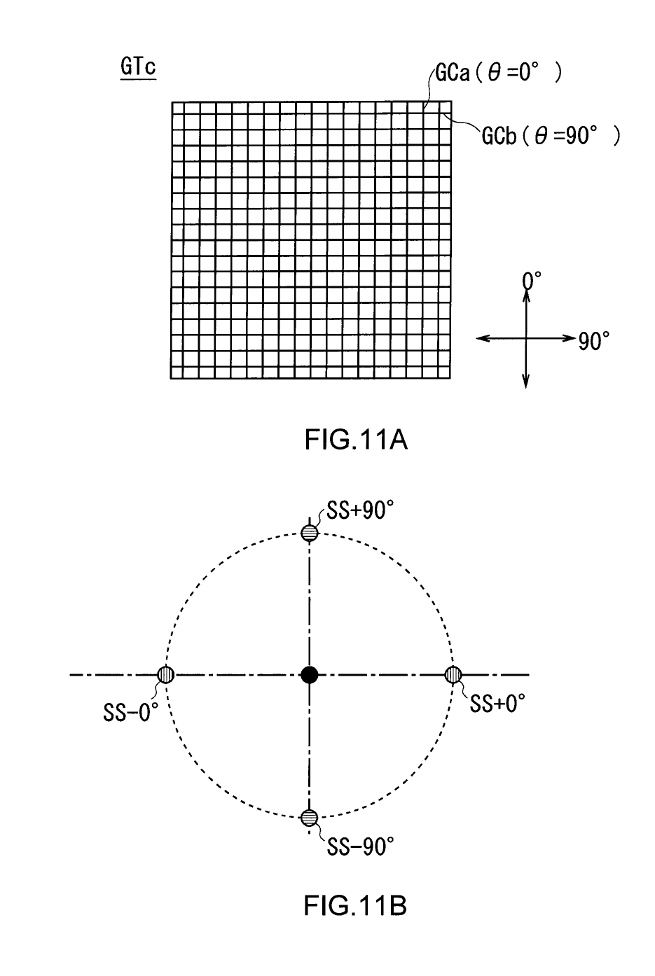

In a diffraction grating GTc shown in FIG. 11A, two diffraction patterns GCa and GCb whose grating angles θ are 0° and 90° cross each other, and, by diffracting the optical beam 40 using the two gratings, light fluxes of the first-order optical beams DF can be dispersed to total 4.

Accordingly, in the optical pickup 1 using the neutral density filter part 2C having the diffraction grating GTc, two first-order light spots SS ±0° by the first-order beam diffracted by the diffraction pattern GCa and two first-order light spots SS ±90° by the first-order beam diffracted by the diffraction pattern GCb can be irradiated on the recording layer of the one-layer disc 100a.

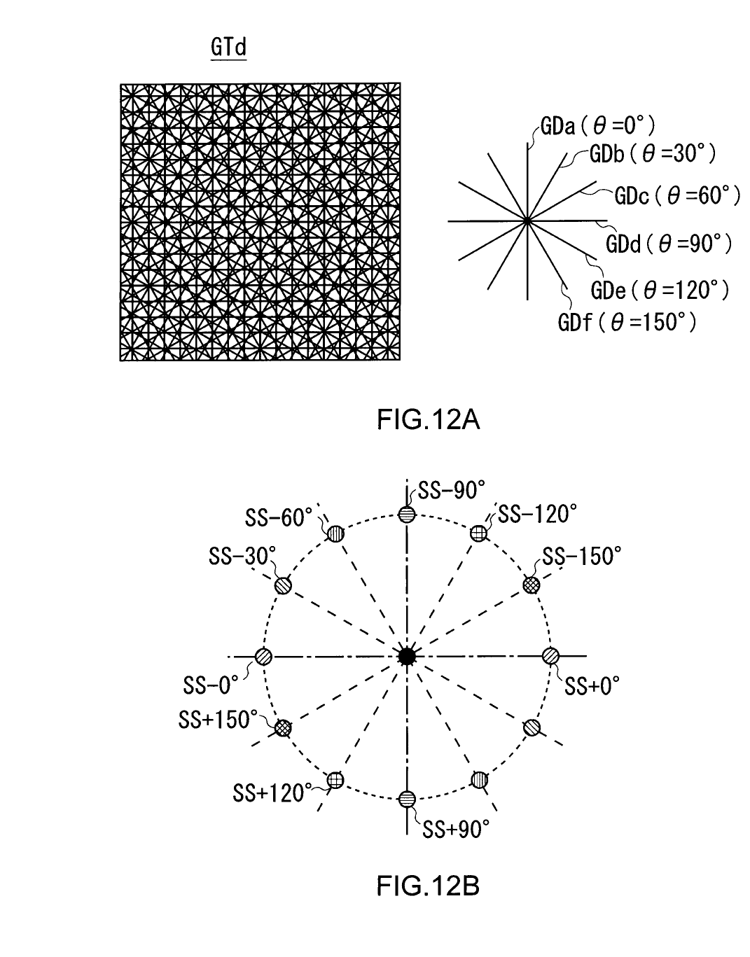

Similarly, as shown in FIG. 12A, in a diffraction grating GTd, six diffraction patterns GDa to GDf whose grating angles θ are 0°, 30°, 60°, 90°, 120° and 150° cross each other.

Accordingly, in the optical pickup 1 using the neutral density filter part 2C having the diffraction grating GTd, light fluxes of the first-order optical beams DF can be dispersed to total 12, and the total of twelve first-order light spots SS±0°, 30°, 60°, 90°, 120°, and 150° can be irradiated on the one-layer disc 100a. The respective first-order spot light intensities can be set to approximately ⅙ of the conventional stripe diffraction grating GTp, that is, reduced to approximately 5% of the transmitted beam 40a.

By making the grating angles θ of the six diffraction patterns GDa to GDf equal to each other and making the diffraction patterns cross each other, the diffraction grating GTd can separate the twelve first-order light spots SS to the maximum, which can surely prevent the first-order light spots SS overlapping mutually.

In this way, in the diffraction grating GTd, by making the six diffraction patterns GDa to GDf, whose grating angles θ are made different from each other, cross each other, and separating the light fluxes of the first-order optical beams DF, the irradiation positions of the first-order optical beams DF irradiated on the one-layer disc 100a (that is, irradiation positions of the first-order light spots SS) can be dispersed, which can sufficiently lower the first-order spot light intensity.

On the other hand, the diffraction grating GTd can sufficiently lower the respective first-order spot light intensities by combining five gratings or seven or more diffraction patterns GD. If the respective diffraction patterns GD are not made equally cross each other, the respective first-order light spots SS do not overlap each other when the grating angles θ in the respective diffraction patterns GD are changed by 10° or more mutually, which can bring about the same effect.

### (2-3-4) Concentric Diffraction Pattern

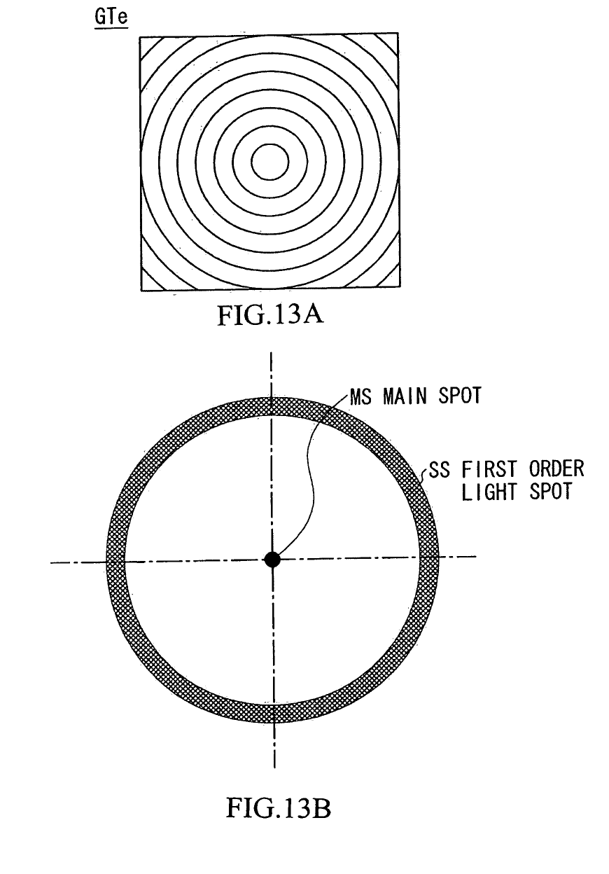

A diffraction grating GTe shown in FIG. 13A has a concentric diffraction pattern of the same period PT.

In the diffraction grating GTe, it can be considered that the grating angles θ are made different from each other in the nonstep manner and continuously, and, by rotating the first-order light spots SS in the nonstep manner and continuously using one diffraction angle φ, light fluxes of the first-order optical beams DF can be dispersed such that the cross section comes to be in the form of a doughnut.

As a result, as shown in FIG. 13B, in the optical pickup 1 using the neutral density filter part 2C having the diffraction grating GTe, the area of the first-order light spots SS can be exponentially increased by extending the figuration of the first-order light spots SS in the form of a doughnut, which can drastically lower the first-order spot light intensity.

In this way, in the diffraction grating GTe of the concentric diffraction pattern, by rotating and dispersing the light fluxes of the first-order optical beams DF in the nonstep manner, the irradiation positions of the first-order optical beams DF irradiated on the one-layer disc 100a (that is, irradiation positions of the first-order light spots SS) can be largely dispersed, and the area of the first-order light spots SS can be increased, which can sufficiently lower the first-order spot light intensity.

In the diffraction grating GTe, when the diffraction pattern is configured by polygons having five angles or more instead of continuous circles, a similar effect can be obtained.

### (3) Operation and Effect

In the above-described configuration, by utilizing the difference between the polarization directions of the optical beam 40 and reflected optical beam 50, the neutral density filter part 2C of the variable filter 2 in the optical pickup 1 reduces the light amount of the optical beam 40 and directs the optical beam 40 to the objective lens 20, and directs the reflected optical beam 50 to the photodetector 22 being a photodetection unit with slight change in the light amount of the reflected optical beam 50. Further, the neutral density filter part 2C diffracts the optical beam 40 using the diffraction grating GT. Accordingly, when reducing the transmitted beam 40a, which is the optical beam 40 transmitted by the diffraction grating GT, the irradiation positions of the first-order optical beams DF being the diffracted±first-order optical beams on the recording layer of the optical disc 100 are dispersed.

Accordingly, since the diffraction grating GT can increase the area of the first-order light spots SS by the first-order optical beams DF on the recording layer, the first-order spot light intensity being the light intensity of the first-order light spots SS on the recording layer, when the area of the main spot MS by the transmitted beam 40a on the recording layer is set to the criterion, can be reduced. Further, an adverse affect with respect to the recording layer of the optical disc 100 such as deleting recording marks on the track peripheral part or deteriorating the recording layer by the first-order light spots SS can be prevented.

In order to set the first-order spot light intensity to 6.3% or lower with respect to the main spot light intensity being the light intensity as the entire spot of the main spot MS, the irradiation positions of the first-order optical beams DF on the recording layer of the optical disc 100 are dispersed.

Accordingly, in case of assuming a case in which the first-order spot light intensity becomes maximum, when the main spot light intensity is highest at the time of the record processing, the reproduction durability of the optical disc 100 is the lowest level, and the spot size of the first-order optical beams DF is narrowed down to the spot size similar to that of the transmitted beam 40a, the first-order spot light intensity can be made smaller than the maximum value of the main spot light intensity which is assumed at the time of the reproduction processing. Accordingly, an adverse affect with respect to the recording layer of the optical disc 100 by the first-order light spots SS can be surely prevented.

Furthermore, by making the grating angles θ of the diffraction pattern different from each other in the diffraction grating GT, the diffraction grating GT can make the directions of the light fluxes of the first-order optical beams DF different from each other according to the grating angles θ, and can rotate the irradiation positions of the first-order optical beams DF on the recording layer of the of the optical disc 100, which can disperse the irradiation positions of the first-order optical beams DF on the recording layer.

By making the grating angles θ of the diffraction pattern different from each other continuously in the diffraction grating GT, as compared with a case of making the grating angles θ different from each other discontinuously and separating the light fluxes, a state in which much more grating angles θ are made different from each other in the nonstep manner is obtained, and clearance between the light fluxes is not formed so that the cross section area thereof can be extended largely. Thus, the irradiation positions of the first-order optical beams DF on the recording layer of the optical disc 100 can be largely dispersed.

Since the diffraction grating GT, has a plurality of grating regions GA whose diffraction patterns are different from each other, the diffraction grating GT can set the diffraction patterns of the respective grating regions GA independent respectively, and can increase the degree of freedom in designing the respective diffraction patterns, which can largely disperse the irradiation positions of the first-order optical beams DF on the recording layer of the optical disc 100.

By making the periods PT of the diffraction patterns different from each other discontinuously in the diffraction grating GT, the diffraction grating GT can improve the degree of freedom in designing diffraction patterns without restriction. Therefore, as compared with a method of making the periods PT different from each other continuously and shifting the focal length of the first-order optical beams DF from the recording layer, the cross section area of the light fluxes of the first-order optical beams DF can be made large significantly by making the periods PT largely different from each other, which can largely disperse the irradiation positions of the first-order optical beams DF on the recording layer of the optical disc 100.

Since the neutral density filter part 2C is provided with a configuration in which the concave parts of the diffraction patterns are filled with birefringent material so that the surface of the diffraction grating GT becomes flat, as compared with a case of using an electrode for the neutral density filter part 2C to provide the polarization dependence, the degree of freedom in designing diffraction patterns can be increased, which makes it possible to divide the diffraction grating GT to the plural grating regions GA, and form a concentric diffraction pattern.

Under the above-described configuration, the neutral density filter part 2C of the variable filter 2 in the optical pickup 1 reduces the transmitted beam 40a by diffracting the optical beam 40 using the diffraction grating GT, and disperses the irradiation positions of the first-order optical beams DF being the±first-order optical beams diffracted by the diffraction pattern on the recording layer of the optical disc 100. At this time, the flat surface of the recording layer of the optical disc 100 is widely used as the irradiation positions of the first-order optical beams DF, and the diffraction angles φ and directions of the diffraction of the first-order optical beams DF is made different from each other with use of the property of the periods PT and grating angles θ of the diffraction grating GT. Accordingly, it is possible to realize an optical pickup and an optical disc device which represents desirable reproduction characteristics even if the neutral density filter part 2C is arranged on the shared light path of the optical beam 40 and the reflected optical beam 50 and desirable reproduction characteristics which do not adversely affect on the optical disc.

### (4) Other Embodiments

In the above-described embodiment, a diffraction element which utilizes a birefringent material for the neutral density filter part 2C and provides the polarization dependence is used, to which the present invention is not restricted. There may be used a diffraction grating which uses photonic crystal and electrodes and provides the polarization dependence. In this case, an effect similar to that in the above-described embodiment can be obtained.

In the above-described embodiment, the diffraction gratings GTa, GTb, GTd, and GTe are used, to which the present invention is not restricted. By randomly forming the periods PT and grating angles θ of the diffraction pattern (not shown), the first-order optical beams DF can be largely dispersed on the recording layer of the optical disc 100 to be substantially scattered.

In the above-described embodiment, the integrated optical circuit 4 is used in the optical pickup 1, to which the present invention is not restricted. Due to various restrictions of space etc., by applying the present invention to the optical pickup 1 in which the variable filter 2 is unable to be arranged between the laser diode 11 and the beam splitter 17, effect similar to that in the above-described embodiment can be obtained.

In the above-described embodiment, the optical disc device 3 corresponds to both the one-layer disc 100a and two-layer disc 100b as the optical disc 100, to which the present invention is not restricted. The optical disc device 3 may correspond to any one of them. In this case, by switching the high transmission part 2B and neutral density filter part 2C in the reproduction processing and record processing, effect similar to that in the above-described embodiment can be obtained.

In the above-described embodiment, the optical pickup 1 switches the high transmission part 2B and neutral density filter part 2C according to the one-layer disc 100a and two-layer disc 100b, scarcely reduces the light amount of the optical beam 40 at the time of the reproduction and record processing with respect to the two-layer disc 100b for which a large irradiation light amount is demanded, and reduces the light amount of the optical beam 40 at the time of the reproduction and record processing with respect to the one-layer disc 100a, to which the present invention is not restricted. There may be employed a configuration in which the high transmission part 2B and neutral density filter part 2C are switched according to the reproduction and record processing, or according to the type of the optical disc 100, and the light amount of the optical beam 40 is scarcely reduced at the time of the processing when a large irradiation light amount is demanded, while the light amount of the optical beam 40 is reduced at the time of the processing when a small irradiation light amount is demanded.

In the above-described embodiment, in order to separate the optical beam 40 irradiated to the optical disc 100 and the reflected optical beam 50 from the optical disc 100, the prism type beam splitter 17 having an optical thin film is used, to which the present invention is not restricted. There may be used a diffraction grating having the polarization dependence as the beam splitter 17. In this case, the beam splitter 17 transmits the optical beam 40 without diffracting the beam 40 due to the polarization state, and diffracts the reflected optical beam 50 to make the beam 50 enter the photodetector 22.

In the above-described embodiment, since the integrated optical circuit 4 is used, the laser diode 11 and photodetector 22 are closely arranged, to which the present invention is not restricted. The present invention can be applied to the case in which the space to separate the optical beam 40 and reflected optical beam 50 is too narrow. For example, the case in which a polarization-dependent diffraction element is used for the beam splitter 17, and only the reflected optical beam 50 is diffracted to be directed to the photodetector 22 corresponds to this. In this case, while the neutral density filter part 2C is arranged between the laser diode 11 and the beam splitter 17, the neutral density filter part 2C can be arranged before the optical beam 40 and the reflected optical beam 50 are completely separated, that is, on the shared light path of the optical beam 40 and the reflected optical beam 50, and effect similar to that in the above-described embodiment can be obtained.

Furthermore, in the above-described embodiment, the optical disc device 3 as an optical disc device is configured by the laser diode 11 as a light source, objective lens 20 as an objective lens, beam splitter 17 as a beam splitter, photodetector 22 as a photodetection unit, neutral density filter part 2C as a neutral density filter part, electromagnetic actuator as a filter drive unit, and control unit 32 as an irradiation light amount control unit, to which the present invention is not restricted. The optical disc device according to an embodiment of the present invention can be configured by a light source, an objective lens, a beam splitter, a photodetection unit, a neutral density filter part, a filter drive unit, and an irradiation light amount control unit of other various configurations.

The optical pickup according to an embodiment of the present invention can be applied to, for example, an optical disc drive of various systems mounted on an electronic device.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup comprising:
a light source that irradiates an optical beam being a linearly polarized light;
an objective lens that condenses the optical beam to make thus condensed optical beam go to an optical disc, and receives a reflected optical beam reflected by the optical disc;
a beam splitter that separates the optical beam and the reflected optical beam;
a quarter-wave plate that converts the optical beam directed from the beam splitter to a circularly polarized light, and converts the reflected optical beam directed to the beam splitter from a circularly polarized light to a polarization direction perpendicular to the optical beam;
a photodetection unit that receives the separated reflected optical beam;
a neutral density filter part that is arranged on the shared light path of the optical beam and the reflected optical beam, and, with use of the difference between the polarization directions of the optical beam and the reflected optical beam, reduces the light amount of the optical beam to direct the optical beam to the objective lens, and directs the reflected optical beam to the photodetection unit with slight change in the light amount of the reflected optical beam; and
a filter drive unit that drives the neutral density filter part on the light path of the optical beam and the reflected optical beam or to the outside of the light path to control the light amount of the optical beam irradiated from the light source so that the optical beam irradiated to the optical disc has a predetermined irradiation light amount,
the neutral density filter part reducing the optical beam that goes through a diffraction grating after diffracted by the diffraction grating, and dispersing the irradiation positions of diffracted±first-order optical beams on the recording layer of the optical disc.

2. The optical pickup according to claim 1, wherein
the diffraction grating disperses the irradiation positions of the±first-order optical beams on the recording layer of the optical disc so that, with respect to the light intensity of the main spot which is obtained when the transmitted optical beam is irradiated to the recording layer of the optical disc, the light intensity of the first-order light spots which are obtained when the first-order optical beams are irradiated to the recording layer for the area of the main spot comes to be 6.3% or lower.

3. The optical pickup according to claim 1, wherein
the diffraction grating disperses the irradiation positions of the±first-order optical beams on the recording layer of the optical disc by making the grating angles of diffraction patterns in the diffraction grating different from each other.

4. The optical pickup according to claim 1, wherein
the diffraction grating disperses the irradiation positions of the±first-order optical beams on the recording layer of the optical disc by making the grating angles of diffraction patterns in the diffraction grating different from each other continuously.

5. The optical pickup according to claim 1, wherein
the diffraction grating disperses the irradiation positions of the±first-order optical beams on the recording layer of the optical disc by having a plurality of grating regions whose diffraction patterns are different from each other.

6. The optical pickup according to claim 1, wherein
the diffraction grating disperses the irradiation positions of the±first-order optical beams on the recording layer of the optical disc by making the periods of diffraction patterns in the diffraction grating different from each other discontinuously.

7. The optical pickup according to claim 5, wherein
the diffraction grating makes the grating angles different from each other for the respective grating regions.

8. The optical pickup according to claim 5, wherein
the diffraction grating makes the periods of the diffraction patterns different from each other for the respective grating regions.

9. The optical pickup according to claim 5, wherein
the grating regions have their areas adjusted so that the light amounts of the passing optical beam become substantially equal to each other among the grating regions.

10. The optical pickup according to claim 5, wherein
the grating angles are different from each other by 10° or more.

11. The optical pickup according to claim 1, wherein
the diffraction grating disperses the irradiation positions of the±first-order optical beams on the recording layer of the optical disc by making a plurality of diffraction patterns of different grating angles cross each other.

12. The optical pickup according to claim 11, wherein
the diffraction patterns cross each other so that the grating angles become equal to each other.

13. The optical pickup according to claim 1, wherein
the diffraction grating disperses the irradiation positions of the±first-order optical beams on the recording layer of the optical disc as the diffraction patterns are concentric.

14. The optical pickup according to claim 1, wherein
the diffraction grating disperses the irradiation positions of the±first-order optical beams on the recording layer of the optical disc by making the periods and grating angles of diffraction patterns different from each other randomly.

15. The optical pickup according to claim 1, wherein
the diffraction grating is provided with a configuration in which the concave parts of the diffraction patterns are filled with a birefringent material so that the surface of the diffraction grating becomes flat.

16. The optical pickup according to claim 1, wherein
the filter drive unit
drives the neutral density filter part on the light path of the optical beam and the reflected optical beam at the time of the processing for an optical disc in which the necessary irradiation light amount is relatively small, and
drives the neutral density filter part to the outside of the light path of the optical beam and the reflected optical beam at the time of the processing for an optical disc in which the necessary irradiation light amount is relatively large.

17. The optical pickup according to claim 1, wherein
the filter drive unit drives the neutral density filter part on the light path of the optical beam and the reflected optical beam at the time of the reproduction processing in which the irradiation light amount for the optical disc is smaller as compared with the time of the record processing.

18. An optical disc device comprising:
a light source that irradiates an optical beam being a linearly polarized light;
an objective lens that condenses the optical beam to make thus condensed optical beam go to an optical disc, and receives a reflected optical beam reflected by the optical disc;
a beam splitter that separates the optical beam and the reflected optical beam;
a quarter-wave plate that converts the optical beam directed from the beam splitter to a circularly polarized light, and converts the reflected optical beam directed to the beam splitter from a circularly polarized light to a polarization direction perpendicular to the optical beam;
a photodetection unit that receives the separated reflected optical beam;
a neutral density filter part that is arranged on the shared light path of the optical beam and the reflected optical beam, and, with use of the difference between the polarization directions of the optical beam and the reflected optical beam, reduces the light amount of the optical beam to direct the optical beam to the objective lens, and directs the reflected optical beam to the photodetection unit with slight change in the light amount of the reflected optical beam;
a filter drive unit that drives the neutral density filter part on the light path of the optical beam and the reflected optical beam or to the outside of the light path; and
an irradiation light amount control unit that controls the light amount of the optical beam irradiated from the light source and the filter drive unit so that the optical beam irradiated to the optical disc has a predetermined irradiation light amount,
the neutral density filter part reducing the optical beam that goes through a diffraction grating after diffracted by the diffraction grating, and dispersing the irradiation positions of diffracted±first-order optical beams on the recording layer of the optical disc.
